(19) United States
(12) Patent Application Publication
(10) Pub. No.: US 2002/0152145 A1
(43) Pub. Date: Oct. 17, 2002

(54) Apparatus and method for standardized banking data system interfaces

(76) Inventors: Rebecca Wanta, Fountain Hill, AZ (US); Eric Castain, Moraga, CA (US)

Correspondence Address: GLENN PATENT GROUP, 3475 EDISON WAY, SUITE L, MENLO PARK, CA, 94025, US

(21) Appl. No.: 09/835,264

(22) Filed: Apr. 13, 2001

(51) Int. Cl. G06F 17/60

(52) U.S. Cl. 705/35

(57) ABSTRACT

Bank business units are described as objects comprising the data for a business unit and the algorithms used to interact with the data. A common infrastructure which include JZEE, event management and/or an object request broker compliant with the common object request broker architecture (COBRA) and JZEE architecture is used to invoke objects in response to service requests initiated by client applications.

### BACKGROUND OF THE INVENTION

1. Technical Field

The invention relates to data processing systems for banking institutions.

2. Description of the Prior Art

Irrespective of the type of a business at hand, the general evolution of diverse data systems is bound to occur as the various facets of an enterprise seek to develop information management strategies and systems that support those ideals. Consider the banking business. It is clear that a large bank will be fragmented into several distinct business units. These business units may cater to completely different customers, or their business base may have some commonality. In either case, as each business unit seeks to improve their customer service, information management mechanisms are developed that are peculiar to the needs exhibited by the business unit and their customers.

At the corporate level of a banking business, the proliferation of dissimilar data processing facilities manifests itself in anarchy. As time marches on, each business unit will continue to promote their own information management systems in accordance with their particular needs. Business units pay little deference to the needs of other business units in the bank and pay just as little, if not less attention to the interoperability concerns that arise at the bank's corporate level. The time and energy required to analyze, design and develop a data processing application at the business unit level has always been enormous. Additional effort to support interoperability between business units and other banks was always required, but hardly ever funded by the institution.

In the banking business, data processing systems comprise subsystems for communications, data retrieval and storage and human interactivity. Modern banking systems further comprise additional subsystems including, but not limited to authentication subsystems, customer information subsystems and the like. Each of these subsystems and the databases that they manage are referred to as a systems of record (SOR). Interoperability at the business unit level required tedious effort in the management of message formats, connection channels, and data mapping and transformation methods to enable dissimilar SORs to interact.

In most instances, a business unit in the bank would be chartered with the development of a new application, and as mentioned previously, the development funding normally did not provide a budget to address system interoperability issues. The SORs that each of the bank's business units developed could not be made compatible without a specific corporate level directive, and the funding to do so. Hence, fiscal constraints would preclude achievement of any pronounced interoperability objectives.

One prior art method of solving the interoperability problem was to insert a middle layer of software that acted as an intermediary between a client application developed by a business unit and the SORs. This can be effectively viewed as merely a data-bus between the various subsystems that a bank is likely to use.

This method works well as long as the client application is only required to operate with a limited number of SORs. By following consistent business rules (data formats and internal structure, mapping of data to other SORs, algorithms, etc.) some level of interoperability could be achieved. The problem becomes much more complex when more than a limited number of SORs are involved. The number of data formats and corresponding business rules implemented in each SOR become arduous, if not impossible to manage. Without the concentric guidance essential to intentionally driving interoperability, banking subsystems evolve independently from one another. This, of course, was the resultant state of the data processing systems that a modern bank relied on in the prior art.

Even if a bank were to decree that a common database dictionary should be used for all software development, this would hardly solve the problem. This only ensures that client applications can access data. It does not address the much more subtle enigma of ensuring that client processes apply the proper algorithms as they manipulate databases integral to each SOR.

What is needed, then, is a system management framework that does more than prescribe a common database model like that of the prior art. A much more robust definition of the communications between subsystems is also required. In addition to this, though, business tasks must be conformed to pre-ordained behavioral definitions. As independent business units develop client applications, these should inherit the attributes of standard object definitions. This would intrinsically lead to highly portable and interoperable management information systems.

### SUMMARY OF THE INVENTION

The methods and apparatus described herein implement a novel and unique facility that provides for the standardization of software development through the use of business objects defined on an enterprise wide basis as well as provides a common infrastructure that allows ‘anywhere’ computing as it maintains separation between the layers which allows any front-end system to connect to any back-end system of record. This common infrastructure is standard based and maintains its independence regarding the user interface, operating system, middleware database and network layers. The present invention is referred to collectively as business object services (BOS). The invention comprises a suite of software components that define various business methods in terms of objects that can be instantiated by a client software module.

The BOS system comprises several layers of interdependent software. Only one of these, the business services interfaces (BSI), is visible to the application developer. Behind the scenes, other software components are working on behalf of the client applications. These components handle communications, server management and distributed object management in a uniform manner. The business objects also implement the business rules that the banking enterprise wants to enforce across all of it's business units.

Only a small portion of the BOS system runs on the same computer that is hosting the client application. The bulk of the system is hosted on computers located in a plurality of general-purpose data centers. The data centers provide automatic load balancing, scalability, and fault tolerance through the use of a distributed object instantiation paradigm. Aside from providing a consistent interface to the SORs, the present invention automatically enforces business rules and logs events.

The BOS system implements the business logic needed to correctly manipulate and interpret data in any given SOR. Business rules can comprise data structures, data mapping and functional logic. These are all integral to the definition of the business objects that comprise the BOS system.

As an illustrative prior art example in a banking environment, wholesale balances in the west-coast could be kept either in customer-visible balance subsystems or in private balance subsystems. East-coast balances can be kept in a separate balance subsystem. A client application, which uses a data bus to get a wholesale balance, must implement all of the rules needed to find the account balances and select which account balance to use. Whereas, a client application that uses the BOS system need only request the balance. The structure of the databases underlying the request and the account references are all inherited from the BOS object.

The BSI, the business systems interface to BOS, provides an application with a single consistent interface to the SOR. The client application does not need to know the details of how information is stored or manipulated. As new SORs are added, or if the location of data is changed, the client application does not need to be re-coded. The BOS system handles the details of communicating to the new systems. Again, all of these characteristics are inherent in the object definitions that describe the bank's business regimen.

The BOS system also provides automatic event logging. This is a single flexible mechanism, which meets statutory bookkeeping and audit requirements for the capture of information about business events. This mechanism also allows processing bottlenecks to be identified and speeds the discovery and correction of hardware and software problems.

The BOS architecture is highly scalable. When a client application requests services, a server is selected from a pool of servers at a central BOS data center. If additional processing resources are needed (e.g., because of increased demand) more servers can be added to the data center. The applications are completely unaware of the change.

The BOS system handles server recovery in a way that is transparent to the client application. If a server should fail, BOS automatically re-routes the client's request to another server. The client is notified only if no servers are available to handle the request. The BOS system uses the same technique to balance process loading across the servers at a data center. This ensures that no single server becomes overloaded and provides the best possible response to all client applications.

The invention comprises a method for structuring a data processing system in a bank that entails the description of the banks business as a collection of objects. These objects include definitions representative of the business rules the bank needs to enforce with regard to manipulating the data in the system. Generally, each SOR in the bank is represented by at least one object. Objects comprise not only the data stored in the SOR, but also comprise the functional code, referred to as methods, that client applications can invoke to perform manipulation of, or simply retrieve the data.

Some client applications have a direct interface with a human user. These can include, but this list is not intended to limit the scope of the invention to teller workstations, automated teller machines, and Internet banking users. Other clients serve other clients exclusively. In the case where a client actually services only other clients, it may be expressed as another object.

Where a client application interfaces with a human user, that application manages all of the interface details and then creates service request needed to interact with the user. Those service requests are then dispatched to the object request broker. The object request broker then passes the service request on to an object that can service the request. Human interface applications can be created for personal workstations, such as those used by bank tellers, personal digital assistants and automated tellers. This enumeration of human interface clients is not to be construed as limiting the invention in any manner.

Client applications do not directly invoke objects. Rather, objects are instantiated by an object request broker via the common infrastructure. The object request broker or event receives requests from a client and then searches for an available object to service the request. In the event an instance of the required object can not be found, the object request broker invokes a new instance of the object. Once a target instance of the object is identified, the object request broker establishes a communications channel between the client and the object instance. The service request is propagated to the object using the channel, but not before the object request broker validates the format of the request. Results from the service request are also conveyed to the requesting client by way of the same communications channel.

An object can be instantiated either on the same computer that the client application is running on or it may be invoked on computer that the client's computer can access over a network. The object request broker normally runs on a computer that is also remote from the computer hosting the client application. Some portions of the object request broker may execute in the same computer as the client.

The object request broker used in the present invention is compliant with the Common Object Request Broker Architecture, a specification promulgated by the Object Management Group. The purpose of this specification is to establish a standardized perspective of object definitions in order to ensure compatibility between objects and clients.

The object request broker can invoke objects in a number of different manners based on the needs of a service request. Objects can be invoked using one of three different synchronization mechanisms, these being synchronous, deferred, or asynchronous message based. The invention can employ other synchronization mechanisms later, so this list is not meant to limit the scope of the present invention. Objects can be invoked as either persistent or temporal and both of these life span types can be invoked either on a transient basis or on a resident basis.

### BRIEF DESCRIPTION OF THE DRAWINGS

The foregoing aspects are better understood from the following detailed description of one embodiment of the invention with reference to the drawings, in which:

FIG. 1 is a flow diagram that depicts the prior art interaction of bank branches with an on-line transaction processing system;

FIG. 2 is a flow diagram that depicts the interaction between branches, Internet users and automated teller machines and the on-line transaction processing system;

FIG. 3 is a functional flow diagram that depicts a request originating at a client and routed to an object by an object request broker;

FIG. 4 is a block diagram that shows the structure of the object request broker interfaces;

FIG. 5 is a block diagram that demonstrates how interface and implementation information is made available to clients and object implementations; and

FIG. 6 is a block diagram that shows the interaction of clients with objects in a bank data processing system.

### DETAILED DESCRIPTION OF THE INVENTION

Modern banking institutions generally have a wide range of data processing needs resultant from an ever-expanding scope of business. In the traditional sense, a banks' primary business is receiving money from depositors, loaning that money to borrowers, charging the borrowers usury for the privilege of borrowing the money and then paying a portion of that interest to the depositors as an incentive to maintain their individual investments. Modernly, banks are also involved with unsecured investment, insurance, and brokerage services. This list of additional business venues is not meant to be limiting, but is set forth merely as an illustration of the types of financial services banks now provide. Most modern banks now segregate these business activities into separate and distinct business units.

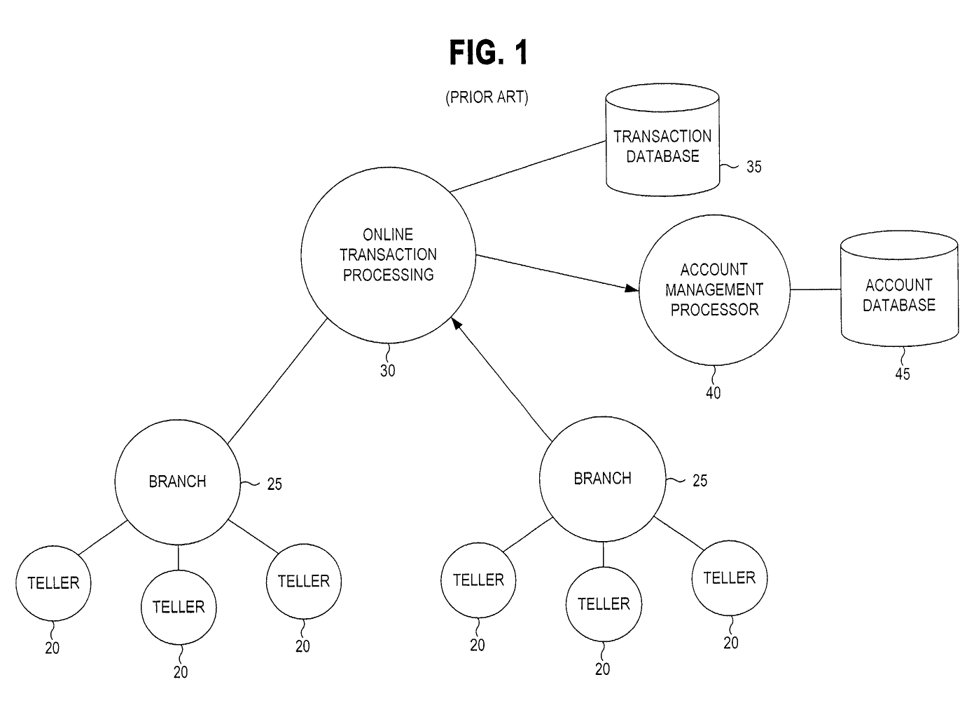

FIG. 1 is a flow diagram that depicts the prior art interaction of bank branches with an on-line transaction processing system. Using modern computing platforms, banks have long been the forerunners in advancing the art of information management. These prior art techniques include an on-line transaction management system. In the prior art, a plurality of tellers' stations 20 would be used to enter transactions. These transactions would be collected at a branch level 25. Once accumulated at the branch level, the transactions would be forwarded to the on-line transaction processing system 30.

The on-line transaction processing system 30 would create a record for every one of the plurality of transactions it received in a transaction database 35. Every transaction would also require the on-line transaction processing system 30 to direct an account debit/credit (Db-Cr) message to an account management processor 40. The account management processor 40 would use the Db-Cr message, which comprised two account numbers and a stated value, to contemporaneously debit and credit the two referenced accounts in accordance with the value amount stated in the message. The new account values would be stored in an account database 45.

From this relatively simplistic overview, it is easy to appreciate that the data flowing from one subsystem to the next must be structured to ensure that the receiving entity comprehends the data messages it receives. For instance, the ordering of the account numbers that the account management processor 40 receives is of vital importance if the transaction is to the posted in the correct direction in both effected accounts. Imagine the havoc that would ensue if the online transaction processing system were to transpose the account numbers in a given message.

This prior art technique was more than adequate if transaction processing was the only information management task the bank needed to perform. A simple policing mechanism could be employed before the system was deployed for service. The software and hardware interface between the varied modules comprising the system could be validated to ensure compliance with a single interface specification.

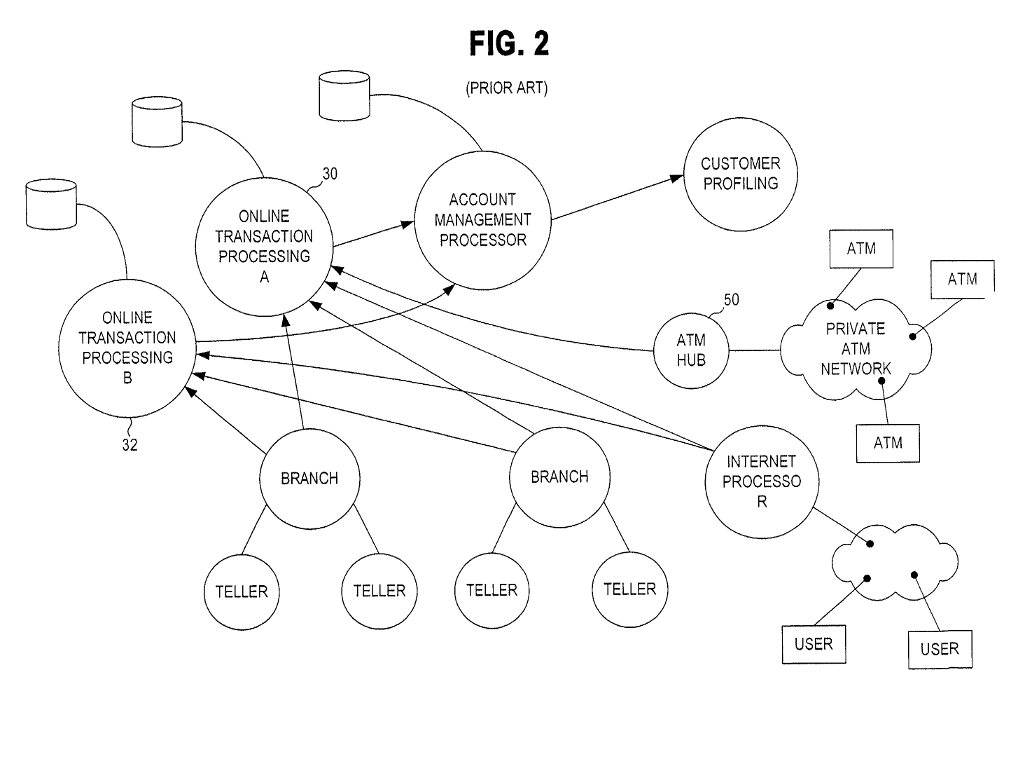

FIG. 2 is a flow diagram that depicts the interaction between branches, Internet users and automated teller machines and the on-line transaction processing system. As can be seen in FIG. 2, once the bank begins to offer a wider array of financial services, the number of interfaces among the various subsystems becomes difficult to manage. In order to ensure that transactions are not lost, the on-line transaction processing system 30 has a redundant facility 32. Hence, when a branch sends a collection of transactions to the on-line transaction processing system 30, it must also direct that collection of transaction records to the redundant system 32.

When an automated teller machine (ATM) transaction is posted, that too, is forwarded by an ATM hub manager 50 to both on-line transaction systems 30 and 32. Internet access by customers also requires additional inter-subsystem interfaces and adds a requirement for heightened security capabilities. Note that in this prior art system, each new data processing facility must conform to the data formats specified by the existing systems. The systems engineering effort that must be devoted in support of this paradigm is can be overwhelming.

The systems engineering effort in prior methods included the traditional creation of interface specifications that define how subsystems within the whole system interact with each other. Establishing the specifications is only the first part of the systems engineering process. Once the specifications are promulgated, there must be a mechanism that ensures compliance with those specifications.

Known information management systems utilized by banks have evolved together with the business base they support. The problem here is obvious. The greater the number of subsystems, the greater the number of interfaces. The complexity of the whole is not based on the complexity of any one given interface, rather it arises from the profusion of interfaces and processes acting in unison. Policing the conformance of the varied subsystems and their interfaces to the promulgated specifications may be possible, but is inevitably time consuming, costly and prone to human error. In the prior art method, droves of systems analysts were engaged in order to certify the conformance of each subsystem to the overall system specification.

Solving the systems engineering dilemma, though, is not so obvious. Reducing the dependence on systems analysts would be one major objective of the present invention in that such reduction results in reduced cost and lessens the probability of human oversights. The present invention has achieved this by integrating the definition of subsystems and their interfaces directly into their respective embodiments through object oriented abstraction.

Object oriented abstraction of a bank's information management systems requires a fundamental shift in the development paradigm. The prior art relied on systems engineers to promulgate specifications. Software and hardware developers then followed the specifications during development and system analysts were employed to ensure compliance with the specifications. In the present art, systems engineers are required to define each element in the system as an object comprising an interface definition and a behavioral definition. Software developers use these abstractions to create conforming objects.

The system analysts of the prior art are replaced by an automated brokerage mechanism that instantiates objects and establishes communication paths between interacting modules. This brokerage mechanism, to some extent, polices the interface between modules. Use of this brokerage mechanism should not be construed as a total subrogation of the role of the system analysts of the prior art. Rather, the brokerage mechanism performs, inter alia, a real time check to ensure that the total number of arguments sent to an object is correct. The real motivation for adopting the brokerage mechanism is that the interface and behavior definitions that would otherwise only be found in specifications are also included in the embodiments of the objects comprising the system.

Object abstraction, then, enables the system engineers responsible for defining the overall structure and implementation of a banks' information processing system to define each function in that system as a complete abstract object. This, though, has its own set of challenges. The definition of objects must still be standardized. This is not nearly as formidable of a barrier as is the adoption of a new overall systems engineering paradigm. Once the system is defined as a set of interacting objects, other aspects of the implementation, although seemingly trivial, are still quite complex.

The banking industry distills the overall information management system into entities called systems of records. Each SOR in a bank is a collection of records that are functionally related. More than likely, an SOR represents the data needs for a particular business unit in the bank.

Domains

A domain is a concept of abstraction that allows partitioning of systems into collections of components that have some characteristic in common. In the present embodiment, system engineers represent an SOR in terms of a domain. Any given domain supports the data processing needs of a particular business unit in the bank. The architecture for any given domain varies in scope but generally comprises a collection of objects, said to be members of the domain, that are associated with some common characteristics. Any object for which the association does not exist, or is undefined, is not a member of the domain. A domain can be modeled as an object and may be itself a member of other domains.

It is the scope of the domain and the object associations or bindings defined therein that characterize a domain. This information is distinct between domains. However, an object may be a member of several domains, of similar kinds as well as of different kinds, and so the sets of members of domains may overlap.

Interoperability between domains is only possible if there is a well-defined mapping between the behaviors of the domains being joined. This mapping is referred to as bridging. Conceptually, a mapping mechanism, or bridge, resides at the boundary between the domains. The bridge transforms requests expressed in terms of one domain's model into the model of the destination domain. Note that the use of the term “bridge” in this context is conceptual and refers only to the functionality which performs the required mappings between distinct domains.

There are several implementation options for such bridges. In one implementation, full interoperability between domains is achieved by transforming concepts used in one domain into the concept form required by all of the other domains the first domain needs to interact with. In another implementation, the bridge mechanism filters out concepts where appropriate. In this method, nothing is lost as far as the supported objects are concerned. In other words, one domain may support a superior service to others, but such a superior functionality will not be available to an application system spanning those domains.

Since interoperability of domains is so crucial, there must be a means of standardizing the expression of concepts among them. Put bluntly, object models in different domains must be compatible. In order to achieve this, the present invention expresses all domains in strict compliance with the common object request broker architecture (CORBA) object model and the CORBA specifications. These specifications are promulgated by the Object Management Group (OMG). The present embodiment also uses the OMG's interface definition language (IDL) for defining interfaces and the CORBA Core interface repository, together with banking industry specific extensions to CORBA that evolved as a result of development of the present invention. Variances from this model could easily compromise some aspects of interoperability between domains.

Object Request Broker (ORB)

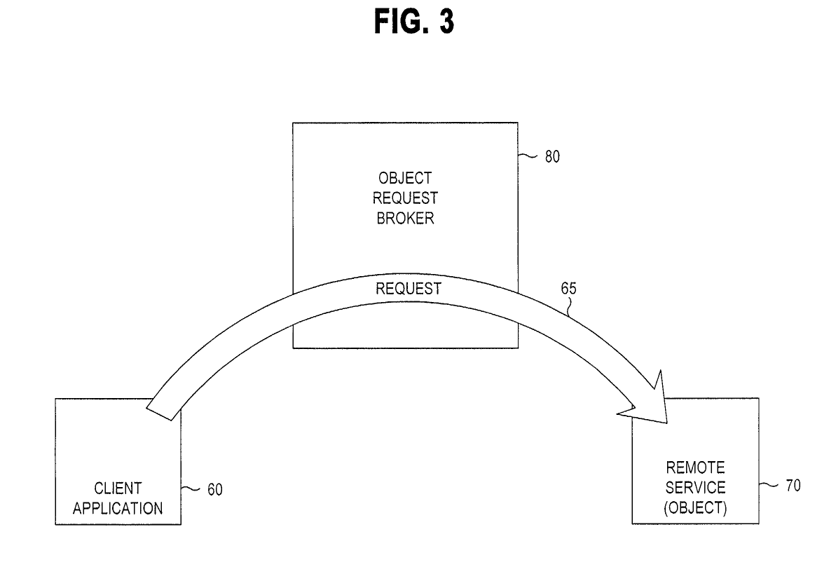

FIG. 3 is a functional flow diagram that depicts a request originating at a client and routed to an object by an object request broker. The client 60 is the entity that needs the object 70 to perform an operation. The object 70, which is sometimes referred to as an object implementation, comprises functional code and the data that the code operates on. The ORB 80 is responsible for all of the mechanisms required to find the object implementation 70 that can service the request 65. The ORB 80 also prepares the object implementation 70 to receive the request 65. At the application level, the client is completely independent of the object's location, what programming language it is implemented in, or any other aspect of the object 70 that is not reflected in the object's interface.

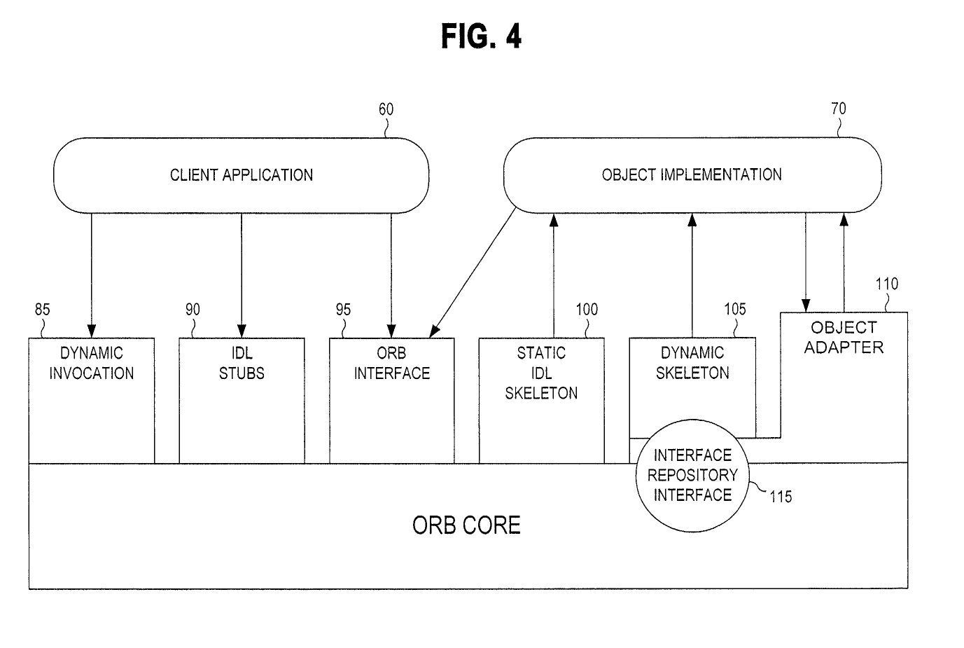

FIG. 4 is a block diagram that shows the structure of the object request broker interfaces. To make a request 65, the client 60 can use the dynamic invocation interface 85. The dynamic invocation interface supports all types of objects. Alternatively, the client 65 can use an IDL stub 90. When the client uses an IDL stub, a specific stub that correlates to a specific target object must be used. The client can also directly interact with the ORB for some functions using the direct ORB interface 95.

The object implementation 70 receives a request as an up-call either through the IDL generated skeleton 100 or through a dynamic skeleton 105. The object implementation 70 may call the object adapter 110 collectively with the ORB while processing a request or at other times. Definitions of the interfaces to objects can be defined in two ways. Interfaces can be defined statically in the interface definition language. This language defines the types of objects according to the operations that may be performed on them and the parameters to those operations. Alternatively, or in addition to the IDL definition, interfaces can be added to an interface repository service 115. The interface repository service 115 represents the components of an interface as objects and permits direct runtime access to these components. In any ORB implementation, the interface definition language and the interface repository service can be extended to meet industry specific requirements. The present invention has created these types of extensions to meet specific needs.

As already disclosed, the client 60 can use either the IDL stub 90 or the dynamic invocation interface 85. The client 60 performs a request by having access to an object reference for an object and knowing the type of the object and the desired operation to be performed. The client initiates the request by calling stub routines that are specific to the object or by constructing the request dynamically. The dynamic and stub interfaces for invoking a request satisfy the same request semantics and the receiver of the message cannot tell how the request was invoked.

In processing the request, the ORB 80 locates the appropriate implementation code, transmits parameters and transfers control to the object implementation 70 through an IDL skeleton 100 or a dynamic skeleton 105. Skeletons are specific to the interface and the object adapter 110 used. In servicing the request, the object implementation 70 may obtain some services from the ORB through the object adapter 110. When the request is complete, control and output values are returned to the client. The object implementation 70 may choose which object adapter to use. This decision is based on what kind of services the object implementation requires.

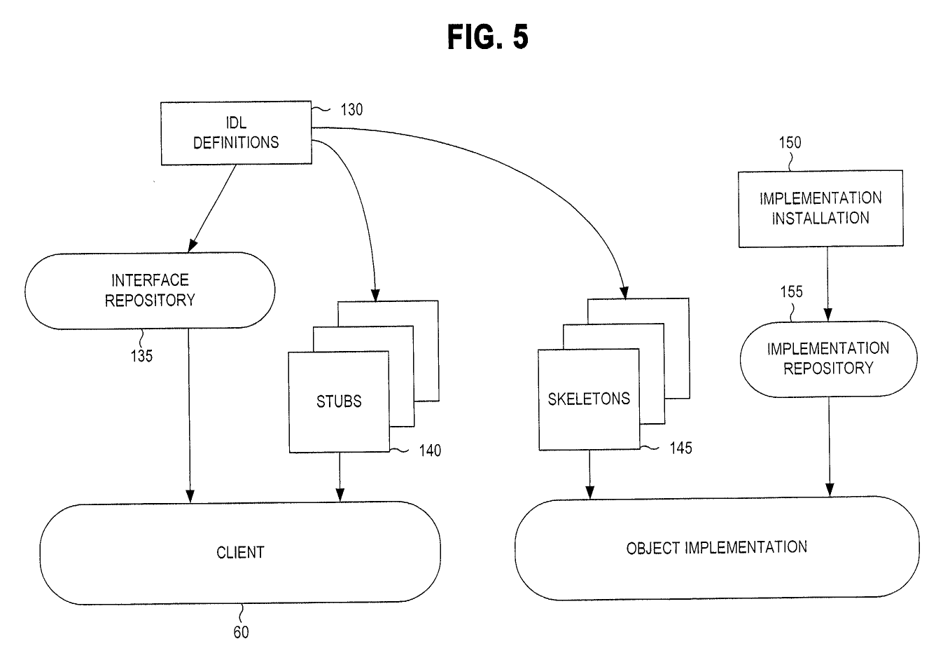

FIG. 5 is a block diagram that demonstrates how interface and implementation information is made available to clients and object implementations. Interfaces are defined in the IDL 130. The IDL definition is placed in an interface repository 135 and is also used to create static interface stubs 140. These can then be accessed by a client application 60. The IDL definition 130 is also used to generate the object implementation skeletons 145. The object implementation information 150 is provided at installation time and is stored in the implementation repository 155 for use during request delivery.

Client Applications

A client application 60 has access to an object reference for an object and can request the object broker to invoke an object. A client application is only privy to the logical structure of objects according to their interfaces and behaviors. Where clients generally see objects and ORB interfaces through the perspective of a language mapping. This brings the ORB right up to the programmer's level. Clients are maximally portable and will be able to operate without source changes on any ORB that supports the desired language mapping with any object instance that implements the desired interface. Clients have no knowledge of the implementation of the object, which object adapter is used by the implementation, or which ORB is used to access it.

CORBA

The present invention exploits a commercially available software product that is tailored to create the object definitions used in the banking industry. These object definitions define the data structures, communication channels and business rules used by a bank and comprise the core of the present invention. The present invention uses a commercial product that is compliant with the Common Object Request Broker Architecture (CORBA). COBRA is a specification that serves as a guidance mechanism that facilitates the creation, deployment, and management of objects in a distributed environment. These objects are generally referred to as distributed components or CORBA components. The present embodiment of the BOS system is founded on CORBA version 1.2 as implemented by BEA's ORB product called ObjectBroker™.

Using the COBRA-compliant ORB (i.e. ObjectBroker), a client application in the present invention can transparently invoke an object on a method server. Later references within this disclosure to the term “ORB” are intended to mean a generic ORB, a COBRA-compliant ORB, the commercial product ObjectBroker, or, as in the preferred embodiment, the commercial ObjectBroker product together with banking industry extensions thereto.

The server object can reside on the same computer as the client or it can be accessed over a network. The ORB intercepts the call and is responsible for finding an object that can service the request. Once the object is identified, the ORB creates a communications channel that the client can use to communicate with the object. The ORB checks to ensure that the client originated parameters are properly formed for the object and invokes the object's method. The client can then communicate with the object to pass parameters and receive the results of the invocation.

The client does not have to be aware of where the object is located, the programming language it is implemented in, its operating system or any other aspects that are not part of an object's interface. Using CORBA, the present invention is embodied as a distributed system that is conceived and implemented as a collection of distributed objects. The interfaces to these objects are described in a high-level, architecture-neutral specification language that also supports object-oriented design abstraction.

The ORB enables client applications to communicate with a remote component in the BOS distributed environment. In other words, the ORB provides transparency of a component's location, activation, communication, and implementation. Thus, the ORB is essential for building and packaging distributed components. Some components of the ORB may execute on both the computer hosting the client application and/or on the server machine.

In a typical distributed object application, the client is thin. The state information for a distributed object is contained directly in the object. Every instance of an object is hosted in a computer called a method server. This results in numerous network requests to the remote object.

The present invention uses mechanisms called factories to enable a client application to instantiate a proxy version of a business object. The present invention provides factories for each of the top-level business objects that define the various business units in an enterprise. In order to use a factory to create an object, the application must first locate the factory and then invoke a method or operation for it. In the banking application of the present invention, separate factories are provided for each business unit: account management; customer service; and transaction processing. This enumeration is not meant to be illustrative and not exhaustive.

In the BSI, proxy objects on the client are used to store state information. When a new object is requested, a remote object is created on the method server contemporaneously with a proxy object on the client computer. When it is first created, the proxy object has no state information. The client application must request the needed data from the remote object. This state information is brought back and merged into the proxy object.

Proxies can only be created by factories and cannot be directly updated by a client application. New or updated information from the server is placed in the proxy when requested. When updated information is returned from a server, only valid returned values are used in the update. Default values, used as placeholders by the server, are not used in the update. This comparison and update takes place transparently to the client.

The BSI provides support for synchronization. Events that normally exist in distinct SORs are not propagated back through an object. Client applications must check for changed values on the remote system and be alert for transactions that are unexpectedly rejected. These behaviors are modeled into each object as appropriate.

Context objects are the mechanism by which BSI session information is communicated to a server process. They are used by sessions, but not directly exposed to client applications. Context objects can be invoked in a number of different manners. These include, but should not be limited to:

synchronous calls;

deferred calls; and

asynchronous message calls;

Synchronous calls are the standard calling method in the current embodiment. A client program calls a routine and then waits until it returns with its results. If the called routine expends a significant amount of elapsed time, this can adversely affect overall processing performance.

By using deferred calls, the calling routine sends the parameters to a server and immediately returns. The client program then continues with its processing until the results are available. This technique is commonly used in interactive processing. If the results are not required immediately, it can greatly increase the apparent speed of processing. After a user makes a request, it is handed off to another process and control returned to the user interface handler. If this were not done, a user would be unable to interrupt a request.

Asynchronous message calls are used by client processes to send a message to an object. The client process does not require any response. Normally, these message based calls are used where objects are invoked using resident life cycles.

In the BSI, the getDeferred interface is used to make a deferred synchronous call. The application invokes getDeferred on an object factory to specify that the returned object will use deferred synchronous methods.

The application then makes the call and gets back a “poller”, which behaves like an object of the type that a synchronous call would return. Standard “gets” are then used to get data from the object. Unlike a standard object, the poller will throw an exception if the data being “got” has not been returned.

An application can use getDeferred to request deferred synchronous calls, invoke a method, continue processing and then periodically check (in a loop or some other mechanism) for the new values using a get. Programmers need to keep in mind that the results can come back at any time, and write their code accordingly.

For client developers, load balancing is transparent. The node manager load balances the business servers. When a client application requests a service from the node manager (via a call to BOSServices), the node manager returns a list of business servers, the nodelist. The list is created using a round robin over the available servers, with greater weighting given to faster servers. The client application then attempts to connect to each server in the list until it is successful. Because the node manager bases its list on a table of currently available servers, it is simple to remove a server from service. The server's entry is removed from the table of available servers and no further connections are made to it. In order to ensure that server connections are periodically refreshed, the nodelist is automatically refreshed and a new connection established when a customer session ends or on certain other events such as the creation of a new customer session.

Load balancing occurs without the client application being aware of any changes. One artifact of this type of load balancing is that object destruction can occur without notifying the client application. Some application may either need an object to persist over some larger time frame and yet other client applications may need the object to remain resident in the method server for improved performance. Hence, the ORB allows the client process to specify the persistence of a spawned object. Client applications can require that objects be instantiated as temporal or persistent and each of these persistence types can be either transient or permanently resident (referred to as resident).

A very desirable artifact of this type of instantiation mechanism is the inherent system redundancy that results. If the connection between a client and an object fails, the ORB automatically attempts to reestablish a connection to a different object. The ORB adheres to specialized connection rules. These rules can require the ORB to limit the number of connection attempts to object on the same method sever. Once that number has expired, the ORB will attempt to invoke a new object on another method server thereby providing hardware redundancy in an entirely transparent fashion. If a connection cannot be reestablished to any of the servers, an error is thrown which the client application must catch.

Against this framework of distributed object management by an object broker, the present invention is further comprised of specialized client application that call upon the ORB to invoke objects.

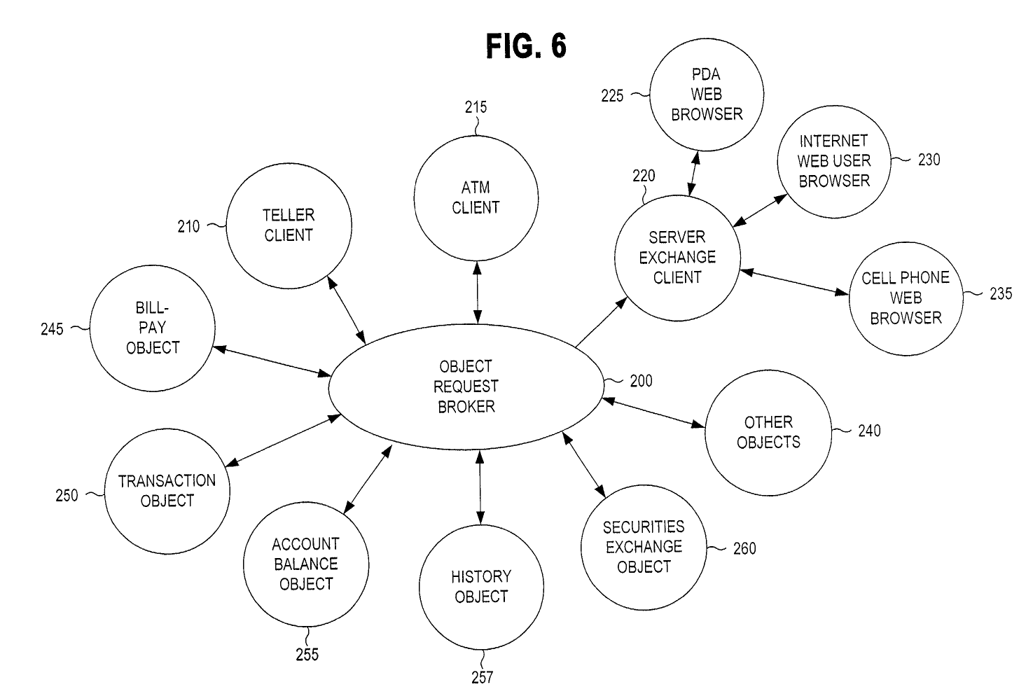

FIG. 6 is a block diagram that shows the interaction of clients with objects in a bank data processing system. An object request broker 200 which is implied within the common infrastructure forms the nucleus of a data processing system according to the present invention. A plurality of clients can request service from a plurality of objects. These elements collectively comprise one embodiment of the present invention. Although FIG. 6 depicts only a limited number and types of clients and objects, this figure is meant to be illustrative only. The actual embodiment of the present invention is scalable and can be extended with new client and object types. Also, FIG. 6 does not depict the notion that objects can be replicated by other instances. Finally, FIG. 6 does not depict the capability of the present embodiment to invoke objects on disparate computing platforms as discussed supra.

A teller client 210 may itself comprise a user interface element that interacts with a human user. The teller client accepts requests for information from the user and these information requests are transformed into a series of service requests directed to a plurality of objects. The teller client will then direct these requests to the ORB 200. The ORB 200, in turn, will identify an object, invoke an instance of the object and communicate the service request to the object. In the event that a teller wants to know the balance in a particular account, the teller client 210 will create a service request for the account balance object 255. That service request is first received by the ORB 200 before being directed to the account balance object 255.

An automated teller machine may also comprise a client that requests service through the ORB. In this case, an ATM client 215 creates service requests when a human user requests some type of transaction. One example, which is ordinarily attributed to an ATM, is a cash withdrawal transaction. When a user requests a stack of $20 bills, the ATM client 215 first sends a service request to the account balance object 255. After having received the account balance from the account balance object 255, the ATM client can determine if cash should be dispensed to the user. Once the cash is dispensed, the ATM client 215 will create an account transaction service request and deliver this to the ORB 200. The ORB will then direct the service request to a transaction object 250. Of course, the ORB 200 will create a new instance of the require object if need be.

Many web browser based devices, such as personal computers (PC) used for Internet banking, cell phones and personal digital assistants (PDAs) can gain access to banking system described here. A server exchange client 220 provides a web-based interface to devices such as these. A PDA web browser 225, a PC-based web browser 230 or a web browser on a cellular telephone 235 can all access information and engage in transactions using the server exchange client 220.

The server exchange client 220 provides a collection of web pages that web browsers can access. Many of these web pages are created dynamically based on information contained in the SORs now embodied in the business objects. Consider a web-based user that wants to access a history of their checking account. The server exchange client creates a service request targeted at an account history object 257. The ORB 200 directs this request to the account history object 257. The ORB 200 directs the resultant history information back to the server exchange client 220. Upon receiving this history information, the server exchange client 220 will dynamically create a web page and deliver this to the requesting user's web browser.

An Internet user may need to sell securities. In this case, the server exchange client 220 interacts with the user to determine what securities are to be sold. A transaction service request for the securities exchange object 260 is formed by the server exchange client 220 and routed to the ORB 200. A similar sequence of events may occur if the user needed to pay a bill. Service request would be created by the server exchange client 220 and then directed to the bill-pay object 245.

In all of these transactions, the ORB 200 first determines if an object is defined. The service request is checked for compliance with the object definitions using either the static or dynamic interface mechanisms. If a valid object exists, the service request is then forwarded to the object. Otherwise, a new instance of the object is first created. Any results from the object are then returned to the requesting client.

1. A method for creating a banking information management system comprising the steps of:
evaluating the data processing needs of a plurality of business units in a bank wherein said evaluation comprises identification of:
data to be processed;
algorithms to be applied to said data;
inputs to be received from the banking unit;
data products to be used internally within the banking unit;
data products that must be delivered to other banking units; and
data products that must be delivered to other entities outside of the bank;
segregating the data processing needs of each of the plurality of business units in the bank into a plurality of functional modules;
defining the behavior of each of said functional modules; and
defining the interaction of each of said functional modules with other said functional modules.

2. The method of claim 1 further comprising the step of
categorizing each of said functional modules as either a client or as an object used by any one client.

3. The method of claim 2 further comprising the steps of:
initiating a plurality of client applications each of which is an autonomous process that interacts either with a human user or another client process;
initiating an object request broker or event that:
receives a request for service from one of the plurality of client applications;
identifies an object that can support the service request;
policies the form of the client request to ensure it is compatible with the form required by said identified object;
initiates a new instance of the identified object; and
creates a communications channel between the client requesting service and the identified object;
allowing the object identified by the object request broker or event to receive the service request from the client using said communications channel; and
allowing the client to receive the results from the object using said communications channel.

4. The method of claim 3 wherein said object request broker or event is hosted on a computer accessible to the client by means of a computer network.

5. The method of claim 3 wherein the object request broker or event initiates a new instance of the identified object on a computer accessible to the client by means of a computer network.

6. The method of claim 3 wherein the object request broker or event is compliant with the common object request broker architecture and middleware event management standards.

7. The method of claim 2 further comprising the step of associating a name with each of said functional modules that are categorized as objects.

8. The method of claim 2 further comprising the step of defining an event service level for each of said functional modules that are categorized as objects.

9. The method of claim 8 wherein the event service level is one of the following: synchronous call, deferred call, or asynchronous message based.

10. The method of claim 2 further comprising the step of defining the life cycle for each of said functional modules that are categorized as objects.

11. The method of claim 10 wherein the life cycle is defined by a first variable that can take one of the following states: persistent; or temporal; and a second variable that can take on one of the following states: transient; or resident.

12. The method of claim 2 further comprising the step of defining the concurrency requirements for each of said functional modules that are categorized as objects.

13. The method of claim 2 further comprising the step of defining the relationship structure for each of said functional modules that are categorized as objects.

14. The method of claim 2 further comprising the step of defining the externalization structure for each of said functional modules that are categorized as objects.

15. The method of claim 1 wherein the definition of the behavior of each of said functional modules comprises an object definition compliant with an object request broker or OMG JZEE standard.

16. The method of claim 1 wherein the definition of the interaction of each of said function modules comprises an interface definition compliant with an object request broker or OMG JZEE standard.

17. The method of claim 2 further comprising the steps of:
identifying those functional modules categorized as clients that have a direct interaction with a human user; and
defining a man machine interface for each of said clients.

18. The method of claim 17 wherein the functional modules categorized as clients that have a direct interaction with a human user are hosted on a personal workstation that is used by a bank teller.

19. The method of claim 17 wherein the functional modules categorized as clients that have a direct interaction with a human user are hosted on a personal digital assistant.

20. The method of claim 17 wherein the functional modules categorized as clients that have a direct interaction with a human user are hosted on an automated teller machine.

21. A banking information management system comprising:
plurality of business objects;
object request broker; JZEE; and standard XML message sets;
plurality of client applications;

22. The system of claim 21 wherein the business objects comprise:
methods that define the business rules for a bank business unit;
databases that contain the information upon which said methods act; and
interface definitions that define how clients request said objects to render service.

23. The system of claim 22 wherein the methods that define business rules are compatible with an object request broker, JZEE and standard XML message sets.

24. The system of claim 22 wherein the interface definitions are compatible with an object request broker JZEE and standard message sets.

25. The system of claim 22 wherein the interface definitions are authored in an interface description language.

26. The system of claim 21 wherein the object request broker JZEE or event management common infrastructure layers:
receives request for service from one of a plurality of client applications;
identifies an object that can service said service request;
ensures that said service request conforms to the interface of said identified object;
invokes a new instance of said identified object;
creates a communications channel between the client application requesting service and said new instance of said identified object;
propagates said service request to said new instance of said identified object using said communications channel; and
receives results from said new instance of said identified object and directs said results to the requesting client application using said communications channel.

27. The system of claim 26 wherein the object request broker or event initiates a said new instance of said identified object on a computer accessible to said requesting client application using a computer network.

28. The system of claim 26 wherein the object request broker or event propagates a service request using a plurality of service levels.

29. The system of claim 28 wherein the said plurality of service levels is one of the following: synchronous call; deferred call; or asynchronous message based.

30. The system of claim 26 wherein the object request broker or event invokes said instance of said identified object using a variable life cycle.

31. The system of claim 30 wherein the variable life cycle can be one of the following four types: persistent and resident; persistent but transient; temporal but resident; or temporal and transient.

32. The system of claim 21 wherein the object request broker or event is hosted on a computer that is accessible to client applications using a computer network.

33. The system of claim 21 wherein the object request broker or event is compliant with the common object request broker architecture specification, JZEE and standard messaging sets.

34. The system of claim 21 wherein the object request broker, JZEE, or event associates a name with each of the plurality of objects.

35. The system of claim 21 wherein the client application comprises:
Inbound interface unit that receives a information request from either another client or a human user;
object service request unit that formulates a service request based on said information request and delivers said service request to the object request broker or event management layer;
logic unit that receives the results from said service request from said object request broker or event management layer within the common infrastructure; and
outbound interface unit that conveys said results to either another client process or a human user.
